(19) United States
(12) Patent Application Publication
(10) Pub. No.: US 2007/0218872 A1
(43) Pub. Date: Sep. 20, 2007

(54) Method and apparatus for automated mapping cell handset location data to physical maps for data mining (traffic patterns, new roads)

(75) Inventors: Gerald W. Pfleging, Batavia, IL (US); George Paul Wilkin, Bolingbrook, IL (US)

Correspondence Address: Richard J. Minnich, Esq.;Fay, Sharpe, Fagan, Minnich & McKee, LLP, Seventh Floor, 1100 Superior Avenue, Cleveland, OH, 44114-2579, US

(73) Assignee: Lucent Technologies Inc.

(21) Appl. No.: 11/377,044

(22) Filed: Mar. 16, 2006

(51) Int. Cl. H04M 3/16

(52) U.S. Cl. 455/410

(57) ABSTRACT

A method and system for the automated mapping of a mobile station and/or handset are provided. The technique includes capturing the identification information of a mobile station, linking a unique tag to the identification information, releasing the identification information of the mobile station, while maintaining the unique tag, tracking the movement of the mobile station through the use of the unique tag and releasing the unique tag after a predetermined amount of time. This method and system could be used for mapping and data mining of traffic flow patterns. As such, this method and system will be useful in determining the amount of use a road may receive automatically, without having traffic counters. It can also be used in determining automatically when new roads have become opened. Furthermore, this data could be used for foot traffic flow through a building.

### BACKGROUND OF THE INVENTION

This disclosure relates to a method and apparatus for gathering mobile station information and more particularly to a method and system for automated mapping of mobile station location data to physical maps.

While the invention is particularly directed to the art of cellular mobile station location data mapping, and will be thus described with specific reference thereto, it will be appreciated that the invention may have other useful fields of application. For example, the invention may be used for mining traffic patterns and/or automated traffic counters.

By way of background, many governments and organizations gather and interpret traffic information manually. These organizations use human sources, such as traffic counters, to measure the amount of traffic that may pass through a given area. This information is often sent to a database in order to be interpreted by traffic engineers. This information is then gathered and interpreted for future use. For example, the government or organization may use this traffic information in order to determine if new roads should be built or if current roads should be repaired. This information may also be used for zoning purposes.

Organizations that offer global positioning systems (GPS) may also use this type of information for mapping roads. Services such as Mapquest and Onstar can use this type of information to enable people to find their ways in cities and towns. They do this by using maps that tell the customer the best route to get to their location. However, these systems are sometimes inaccurate because new roads are being built and routes are being changed in real time. Unfortunately, all of the above mentioned organizations need the information to be constantly updated in order to remain accurate.

There is a need in the industry for a service that can map the physical location of traffic in real time. Furthermore, there is a need in the industry that will allow this kind of mapping to take place, while still respecting the privacy concerns of the public. The present disclosure contemplates a new and improved system and method for resolving the above-referenced difficulties and more.

### SUMMARY OF THE INVENTION

A method and system configured for automapping mobile station location are provided.

In one aspect of the presently described embodiments, a method includes capturing identification information of a mobile station, linking a unique tag to the identification information, releasing the identification information of the mobile station device while still maintaining a unique tag, tracking the movement of the mobile station device through the use of the unique tag, and releasing the unique tag after a pre-determined amount of time.

In another aspect of the presently described embodiments, the method also includes tracking traffic flow data.

In another aspect of the presently described embodiments, the method may also include releasing the unique tag after a pre-determined time of inactivity.

In another aspect of the presently described embodiments, the method will include implementing a random number generator in order to create the unique tag.

In another aspect of the presently described embodiment, the method includes capturing and releasing the mobile station's electronic serial number (ESN) in order to link the unique tag.

In another aspect of the presently described embodiments, the method may also include storing the unique tag in the home location register of the mobile station.

In another aspect of the presently described embodiments, the method may further include storing the unique tag in a centralized home location register.

In another aspect of the presently described embodiments, a system is used for the automated mapping of a cellular mobile station which would include a registration module that captures the mobile station's identification information links a unique tag to the identification information, and releases the identification information while maintaining the unique tag, a tracking module that tracks a mobile station thorough the unique tag that has been linked to the mobile station, and a release time threshold that will signal a release of the unique tag after a pre-determined amount of time.

In another aspect of the presently described embodiments, the system may also include the mobile station's identification information being an electronic serial number.

In another aspect of the presently described embodiments, the system may also include a random number generator that will generate a number for the unique tag.

In another aspect of the presently described embodiments, the system may also include a method of automated mapping for a cellular mobile station comprising, capturing the electronic serial number of a cellular mobile station when the cellular mobile station is registering with a base station, generating a unique tag for the cellular mobile station, linking the unique tag to an electronic serial number of the cellular mobile station, releasing the electronic serial number of the cellular mobile station, tracking the cellular mobile station through the unique tag, and releasing the unique tag after a pre-determined amount of time.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 illustrates a portion of the communications network including a public network, a mobile switching center (MSC), one or more base stations and a mobile station.

FIG. 2 illustrates the expanded version of the communications network which includes a public network, an MSC, a signal transfer point (STP) and enhanced media resource center (eMRS), a MiLife® Application Server (MAS), an enhanced service manager (eSM), a database server and a roadway system.

FIG. 3 is a flow chart illustrating the method according to the presently described disclosure.

FIG. 4 illustrates the automated mapping system according to an embodiment of the present disclosure.

### DETAILED DESCRIPTION OF THE PREFERRED EMBODIMENTS

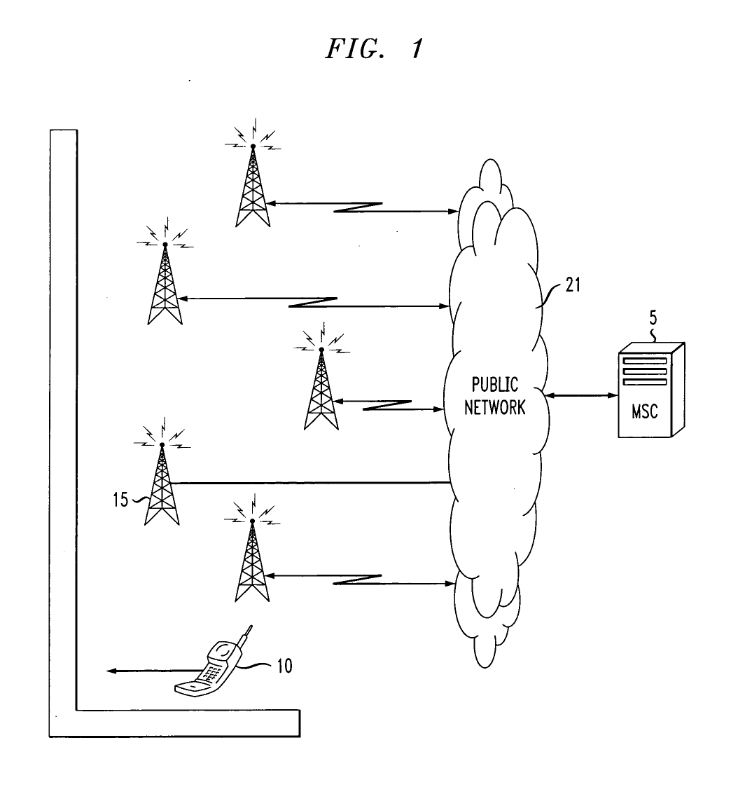

Referring now to the drawings wherein the showings are for purposes of illustrating the exemplary embodiments only and not for purposes of limiting the claimed subject matter, FIG. 1 provides a view of a system into which the present invention may be incorporated. As shown generally, FIG. 1 is a communications network infrastructure. The communications network infrastructure includes a public network 21, and mobile switching center (MSC) 5, at least one base station 15 and a mobile station 10.

The presently described embodiments include a method for automated mapping of mobile station location data to physical maps for data mining. This technique contemplates a form of tracking mobile stations for use in gaining insight into traffic patterns for the purposes of traffic navigation and mapping. In one form, this service maps the traveler's mobile stations without violating the privacy rights and concerns of the public.

Still referring to FIG. 1, the mobile station 10 could be a variety of different communication devices, including, but not limited to a wireless telephone, a handset, a laptop computer, a PDA, a Wi-Fi phone, etc. Generally, each mobile station has a unique identifier, usually an electronic serial number (ESN), which is a 32-bit number programmed into the mobile station when it is manufactured that is unique to that mobile station 10. The mobile station 10 registers its unique identifier, usually its ESN, with the service provider 21 whenever it enters into the network. Typically, the mobile station 10 transmits a registration request, and the MSC 5 keeps track of the mobile station's location in a database. This way, the network provider 21 knows in which cell the mobile station is in as it travels. In this respect, the communication of the ESN of the mobile station 10 is received through the public network 21. As the mobile station 10 travels along its path, it will stay in communication with the base station(s) as it enters into new cells and leaves old ones. This is done in order to ensure that a user is able to receive a call as well as maintains its current call as the mobile station 10 is traveling.

The system will then correlate or tie a unique tag to the ESN of the mobile station 10 and then release the ESN. The mobile station 10 can then be tracked through the unique tag in a database, without exposing the unique ESN to those that can access that database. In this fashion, the mobile station 10 can be followed for a period of time, while the unique tag is not expired. All the while, the mobile station's 10 ESN is concealed from that database.

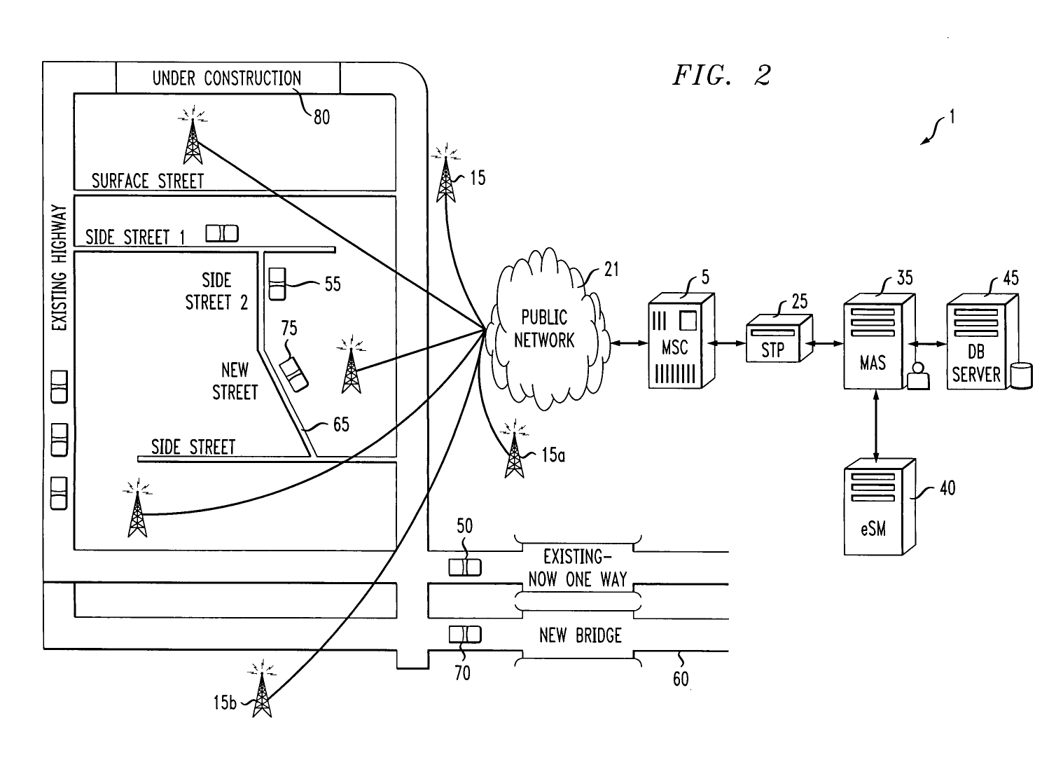

Now referring to FIG. 2, an expanded communications network is shown generally at 1. This network includes a public network 21, an MSC 5, a Signal Transfer Point (STP) 25, MiLife® Application Server (MAS) 35, enhanced Service Manager (eSM) 40, a database server 45, communication base stations 15, a road that is under construction 80, vehicles 50, 55 traveling on known transportation routes and vehicles 70,75 traveling on new transportation routes 60, 65 respectively.

As stated above, when a mobile station registers with the system, the base station 15 receives a unique identifier, usually the ESN. If the base station is part of the network that is configured to run this method, the system will tie a unique tag to the ESN, as long as the mobile station does not already have one registered. If the mobile station does already have one, the system will record the unexpired unique tag that was previously assigned to the mobile station in the system.

In the present embodiment, an eSM 40 works in conjunction with the database server 45 in order to enable the system to provide a secure environment for subscriber database information. Therefore, the database server 45 can tie a unique tag to the registered ESN and then release the ESN which is described in further detail below. The eSM 40 would then keep this information secure in order to protect the privacy of the users as system tracks the mobile station.

In some cases, the mobile station, while being tracked by the unique tag, will send a signal to the cell's base station 15b that will reflect that the mobile station is on an unregistered and/or new road. For example, when vehicles 70, 75 register on the network, the signal may indicate that the vehicles 70, 75 are headed for a new bridge 60 or is driving on a new road 65. Using this system, subscribers may send out a surveyor in order to investigate, or may simply rely on the system and adjust their maps in order to reflect that a new route 60, 65 has been established. Subscribers may also make negative inferences from this information as well. If there has been no mobile stations using the road 80, it may be fair to assume that the road in no longer a viable route.

FIG. 2 also discloses an MAS 35. The MAS 35 is a server that offers a next-generation converged services platform and an open-interface, programmable and media independent application. This can be useful in enabling concurrent service capabilities for the network. This network element can also offer services such as iLocator, SurePay Solution Suite, Unified Subscriber Data Server, Intelligent Services Gateway, Presence, etc. Although this embodiment discloses a MAS 35, other mobile software application servers that offer different services can be substituted into the disclosed system.

An STP 25 may also assist in the tracking of the mobile station. The STP 25 is a switch that provides for the transfer from one signaling link to another. As a user travels from point to point with their mobile station in a vehicle 50, the STP 25 is used to communicate with the network 21 in order to set up and tear down phone calls as they move from cell to cell. Through the STP 25, the system tracks the movement of a mobile station 10 (FIG. 1) and in turn a vehicle 50 housing the mobile station 10 (FIG. 1). For example, a vehicle 50 may be traveling from one base station's 15a cell to another base station's 15b cell. Through the use of the STP 25 the system can pinpoint the location of the mobile station 10 and thereby locate the vehicle 50.

The system may also track the mobile station 10, through the unique tag, by polling the area for the mobile station's signal. In this embodiment, the system can track the mobile station even if the mobile station remains in the same geographic area (i.e. inside the same cell site) for long periods of time. This method of polling the mobile station can be implemented at various times. For example, in one embodiment, the system polls the mobile station only when a mobile station has not reregistered in the system for period of time. In another embodiment, the system polls the mobile station in order to track its location every few minutes. In another embodiment, polling is done every few seconds. In yet another embodiment, polling is done on demand. The location of a mobile station can be pinpointed based on triangulation signaling or any other method which is known to those skilled in the art.

After a predetermined amount of time, the unique tag will expire. Once the unique tag is expired, the unique tag is released from that mobile station, and the unique tag may be reused on a different mobile station.

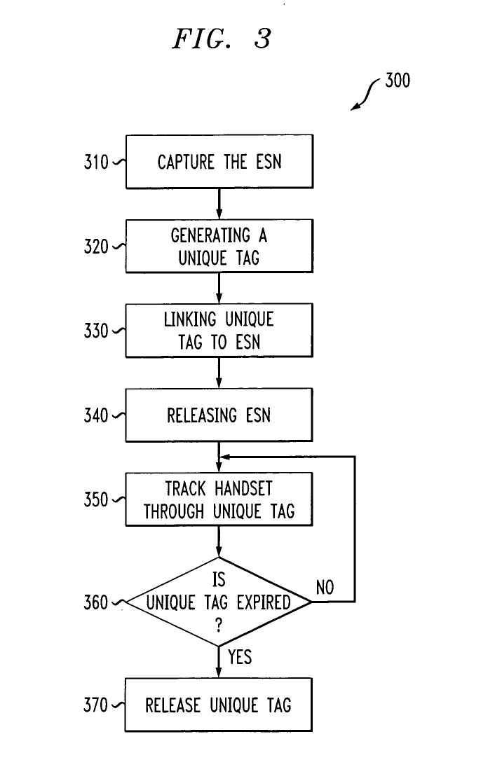

Now referring to FIG. 3, a method of automapping of a cellular mobile station location data is shown generally at 300. It should be understood that the method may be implemented in a variety of software and hardware configurations. In one form, the software implementing the method of FIG. 3 resides in the MSC (5, FIG. 2). In another form, the software implementing the method of FIG. 3 resides in the STP 25. In another form, at least a portion of the software resides in the database server 45. In yet another form, at least a portion of the software resides in the eSM 40. In yet another form, at least a portion of the software resides in the mobile software application server 35. In still another form, the software may be distributed among any and/or all suitable network elements.

As shown, the method 300 includes capturing the ESN (at 310). The ESN can typically be captured when the mobile station is registering the network. However, it should be noted that the ESN can be captured at any given point in time, including whenever initiating the tracking process. It should also be noted that other unique identifiers can also captured.

The method continues with generating a unique tag (at 320). The unique tag can be implemented in a variety of forms. Generally, the unique tag is a number and/or letter combination that is used to identify the mobile system that has been registered on the network. The unique tag will be used to identify that individual mobile station during the period of time in which it is being tracked. However, in the exemplary embodiment, the unique tag will not be related to the ESN in any meaningful way. Furthermore, in some embodiments, there will be no ties that can link the unique tag to the ESN.

However, as the method continues (at 330), the unique tag is linked to the ESN. However, as previously stated above, the linked unique tag will not be related to the ESN in any meaningful way. For example, the unique tag can be generated by a random number generator and should be capable of being linked to any and every available ESN. This is done in order to ensure that the unique tag cannot easily be traced to an ESN. However, the linking to an ESN is useful in order to ensure that the unique tag is linked to one and only one mobile station for the pre-determined period of time. In one embodiment the unique tag is stored in the home location register (HLR) and/or the centralized HLR.

The method 300 continues with releasing the ESN (at 340). As noted above, the ESN will be released in order to ensure the privacy of the public. Once the ESN is released, there will be no meaningful way to connect the unique tag with any individual ESN. However, in some forms, if that mobile station goes off line and then comes back online, that unique tag may still be identified with that original mobile station. For example, if a vehicle (50, FIG. 2) is housing a mobile station that the system is tracking and that vehicle 50 goes out of range for a short period of time, if that same mobile station comes back within range before the unique tag is set to expire, that mobile station will still receive the same unique tag that it had before it went out of range. This way the mobile station can be tracked for the life of the unique tag. This can be done by storing the unique tag in the HLR. In this form wherever the mobile station reregisters with a base that is capable of implementing this method, it will consult the HLR, and the HLR will communicate the unique tag to the system as long as the unique tag is not expired.

The method 300 continues with tracking the mobile station through the use of the unique tag (at 350). The mobile station can be tracked through the use of the unique tag, in such a case it is not necessary to maintain the ESN that is associated with that unique tag. Referring back to FIG. 2, if vehicle 50 has a mobile station that is registered on a base station 15a, the unique tag will be used to track that vehicle 50. Furthermore, if that vehicle 50 and any other tracked vehicles access a new road 60 that has not yet been mapped, a surveyor can have advanced warning that the new road may indeed be open because of the noticeable traffic flow. The vehicle may be tracked during the registration and reregistration processes and/or by implementing a polling method. Also, the vehicle's location can be pinpointed by using triangulation signaling or any other suitable method known in the art.

The method 300 continues with determining if the unique tag is expired. This method 300 of tracking should operate while the unique tag is not expired. Once the unique tag is expired, the method finishes with releasing the unique tag at 370. The longer the period of time that the unique tag is operable, the more tracking information data there will be. However, the longer the period of time that the unique tag is operable, the more there will be concerns dealing with public privacy.

The unique tag can be set to expire in a variety of different times depending on the functionality of the system. In one embodiment, the unique tag is set to expire a certain period of time after it has comes online. For example, a unique tag may be set to expire three hours after it has registered. In this embodiment, whenever the unique tag comes online, it will expire three hours later. For example, if a unique tag comes online at midnight, it will expire at 3 a.m. In another embodiment, the unique tags will be used to track traffic at a certain amount of time during the day. For example, the system may be used in order to track traffic during a rush hour period. In this embodiment, the method may be set to run for many mobile stations beginning at 7 a.m. In this form, all unique tags, regardless of when they became operable, may be set to expire at 9 a.m. Therefore, a tag may be operable for any given amount of time within that time period. However, no unique tag would be operable for more than two hours in this embodiment. In another form, the method can be implemented on demand. For example, if there is a traffic backup, this method could be implemented in order to track where the mobile units are going.

Once the unique tag is released (at 370) that same tag could be tied to a new ESN once the method is rerun. However, in this exemplary embodiment, that unique tag will not be reassigned to the same mobile station and/or ESN after the tag has expired.

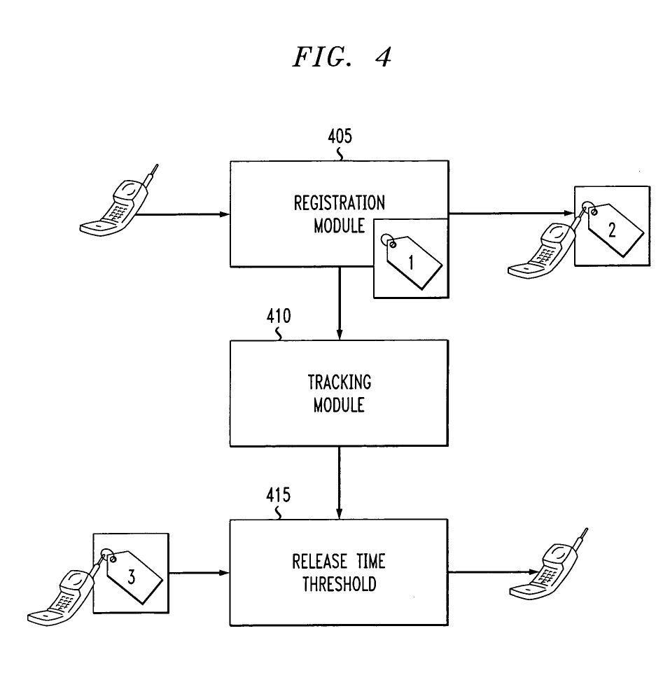

Referring now to FIG. 4, one embodiment of the system 400 is displayed. It should be noted that the tag in this figure is for illustrative purposes and it is not necessary for a physical tag to be placed on the mobile station. It should be understood in this embodiment that the tag refers to data. In this embodiment, the system includes two modules; a registration module 405 and a tracking module 410. The system 400 also includes a release time threshold 415. It should be noted that these modules can be implemented in a variety of different forms. Furthermore, these modules could exist in a variety of different hardware configurations. It should also be noted, as stated before, this software could be implemented into a unified messaging server, an MSC, an STP, an ESM and/or a variety of other different network components. This example is for illustrative purposes only.

The registration module 405 is the module that would capture the ESN of the mobile station (310, FIG. 3), link a unique tag to the ESN and/or the mobile station (330, FIG. 3), and release this ESN while maintaining the unique tag (340, FIG. 3). The unique tag, which could be generated by a random number generator (not shown), would not be released (370, FIG. 3) until the system 400 reaches the release time threshold 415.

While the release time threshold 415 has not been reached, a tracking module 410 will be used to track the mobile station that has been associated with the unique tag. Furthermore, the unique tag will be attached to the mobile station as long as the time release threshold 415 has not been reached, even if the mobile station has gone off line and had to be re-registered. Stated another way, if the mobile station goes offline, the same unique tag will reattach to the mobile station when it re-registers with the network, as long as the time release threshold has not been met. Therefore, this tracking module 410, will be able to track the same mobile station during the entire time threshold 415.

The above description merely provides a disclosure of particular embodiments of the invention and is not intended for the purposes of limiting the same thereto. As such, this disclosure is not limited to only the above-described embodiments. Rather, it is recognized that one skilled in the art could conceive alternative embodiments that fall within the scope of the invention.

We claim:

1. A method for automated mapping of a mobile station comprising:
capturing identification information of a mobile station linking a unique tag to said identification information;
releasing said identification information of said mobile station while maintaining said unique tag;
tracking the movement of said mobile station through the use of said unique tag; and,
releasing said unique tag after a predetermined amount of time.

2. A method according to claim 1 further comprising tracking said mobile station through polling methods.

3. A method according to claim 1 further comprising releasing said unique tag after a predetermined time of inactivity.

4. A method according to claim 1 further comprising implementing a random number generator to create said unique tag.

5. A method according to claim 1 further comprising capturing and releasing said mobile station's electronic serial number.

6. A method according to claim 5 further comprising linking said unique tag to said mobile station's electronic serial number.

7. A method according to claim 1 further comprising storing said unique tag in a home location register.

8. A method according to claim 7 further comprising storing said unique tag in a centralized home location register.

9. A method according to claim 1 further comprising tracking said mobile station using triangulation tracking.

10. A system for the automated mapping of a cellular handset comprising:
a registration module that captures a mobile station's identification information, links a unique tag to said identification information and releases said identification information while maintaining said unique tag;
a tracking module that tracks said unique tag that has been linked to said mobile station;
a release time threshold that will signal a release of said unique tag after a predetermined amount of time.

11. A system according to claim 10 wherein said mobile station's identification information is an electronic serial number.

12. A system according to claim 10 further comprising a random number generator that generates a number for said unique tag.

13. A system according to claim 10 wherein said identification information is an electronic serial number.

14. A system for automated mapping of a mobile station comprising;
a means for capturing identification information of a mobile station;
a means for linking a unique tag to said identification information;
a means for releasing said identification information of said mobile station while maintaining said unique tag;
a means for tracking the movement of said mobile station through the use of said unique tag; and,
a means for releasing said unique tag after a predetermined amount of time.

15. A system according to claim 14 further comprising a means for tracking said mobile station through polling.

16. A system according to claim 14 further comprising a means for randomly generating a unique tag.

17. A system according to claim 14 further comprising a means for linking said unique tag to said mobile station's electronic serial number.

18. A system according to claim 14 further comprising a means for storing said unique tag in a home location register.

19. A system according to claim 14 further comprising a means for triangulation tracking of said mobile station.

20. A method of automated mapping for handsets comprising:
capturing the electronic serial number of a handset when said cellular handset is registering with a base station;
generating a unique tag for said handset;
linking said unique tag to the electronic serial number of said handset; and
releasing the electronic serial number of said handset;
tracking handset through the unique tag;
releasing the unique after the predetermined amount of time.
